(19) United States
(12) Patent Application Publication
(10) Pub. No.: US 2003/0121287 A1
(43) Pub. Date: Jul. 3, 2003

(54) Fusion processes for producing sheet glass

(76) Inventors: Paul G. Chalk, Danville, KY (US); Philip M. Fenn, Corning, NY (US); Dawne M. Moffatt-Fairbanks, Horseheads, NY (US)

Correspondence Address: Maurice M. Klee, Ph.D., Attorney at Law, 1951 Burr Street, Fairfield, CT, 06824, US

(21) Appl. No.: 10/326,685

(22) Filed: Dec. 20, 2002

Related U.S. Application Data
(60) Provisional application No. 60/343,439, filed on Dec. 21, 2001.

(51) Int. Cl. C03B 17/06

(52) U.S. Cl. 65/90; 65/53; 65/195

(57) ABSTRACT

Methods are provided for controlling the formation of defects in sheet glass produced by a fusion process which employs a zircon isopipe. The methods comprise controlling the temperature profile of the glass as it passes over the isopipe so as to minimize both the amount of zirconia which diffuses into the glass at the top of the isopipe and the amount of zircon which comes out of solution at the bottom of the isopipe.

### CROSS REFERENCE TO RELATED APPLICATION

This application claims the benefit under 35 USC § 119(e) of U.S. Provisional Application No. 60/343,439 filed Dec. 21, 2001, the content of which in its entirety is hereby incorporated by reference.

### FIELD OF INVENTION

This invention relates to fusion processes for producing sheet glass and, in particular, to fusion processes which employ zircon isopipes. Even more particularly, the invention relates to controlling the formation of zircon-containing defects in sheet glass produced by fusion processes employing zircon isopipes.

The techniques of the invention are particularly useful when fusion processes are employed to produce glass sheets for use as substrates in the manufacture of liquid crystal displays, e.g., AMLCDs.

### BACKGROUND OF THE INVENTION

The fusion process is one of the basic techniques used in the glass making art to produce sheet glass. See, for example, Varshneya, Arun K., “Flat Glass,” Fundamentals of Inorganic Glasses, Academic Press, Inc., Boston, 1994, Chapter 20, Section 4.2., 534-540. Compared to other processes known in the art, e.g., the float and slot draw processes, the fusion process produces glass sheets whose surfaces have superior flatness and smoothness. As a result, the fusion process has become of particular importance in the production of the glass substrates used in the manufacture of liquid crystal displays (LCDs).

The fusion process, specifically, the overflow downdraw fusion process, is the subject of commonly assigned U.S. Pat. Nos. 3,338,696 and 3,682,609, to Stuart M. Dockerty. A schematic drawing of the process of these patents is shown In FIG. 1. As illustrated therein, molten glass is supplied to a trough formed in a refractory body known as an “isopipe.” Once steady state operation has been achieved, molten glass overflows the top of the trough on both sides so as to form two sheets of glass that flow downward and then inward along the outer surfaces of the isopipe. The two sheets meet at the bottom or root of the isopipe, where they fuse together into a single sheet. The single sheet is then fed to drawing equipment (shown as glass pulling rolls in FIG. 1), which controls the thickness of the sheet by the rate at which the sheet is drawn away from the root. The drawing equipment is located well downstream of the root so that the single sheet has cooled and become rigid before coming into contact with the equipment.

As can be seen from FIG. 1, the outer surfaces of the final glass sheet do not contact any part of the outside surface of the isopipe during any part of the process. Rather, these surfaces only see the ambient atmosphere. The inner surfaces of the two half sheets which form the final sheet do contact the isopipe, but those inner surfaces fuse together at the root of the isopipe and are thus buried in the body of the final sheet. In this way, the superior properties of the outer surfaces of the final sheet are achieved.

### THE PROBLEM WHICH THE INVENTION SOLVES

An isopipe used in the fusion process is subjected to high temperatures and substantial mechanical loads as molten glass flows into its trough and over its outer surfaces. So as to be able to withstand these demanding conditions, the isopipe is typically and preferably made from an isostatically pressed block of a refractory material (hence the name “iso-pipe”). In particular, the isopipe is preferably made from an isostatically pressed zircon refractory, i.e., a refractory composed primarily of ZrO₂ and SiO₂. For example, the isopipe can be made of a zircon refractory in which ZrO₂ and SiO₂ together comprise at least 95 wt. % of the material, with the theoretical composition of the material being ZrO₂.SiO₂ or, equivalently, ZrSiO₄.

In accordance with the invention, it has been discovered that a major source of losses in the manufacture of sheet glass for use as LCD substrates is the presence of zircon crystals (referred to herein as “secondary zircon crystals” or “secondary zircon defects”) in the glass as a result of the glass' passage into and over the zircon isopipe used in the manufacturing process. It has been further discovered that the problem of secondary zircon crystals becomes more pronounced with devitrification-sensitive glasses which need to be formed at higher temperatures.

### THE DISCOVERY OF THE SOURCE OF THE PROBLEM

In accordance with the invention, it has been found that the zirconia which results in the zircon crystals which are found in the finished glass sheets has its origin at the upper portions of the zircon isopipe. In particular, these defects ultimately arise as a result of zirconia (i.e., ZrO₂ and/or Zr⁺⁴+2O⁻²) dissolving into the molten glass at the temperatures and viscosities that exist in the isopipe's trough and along the upper walls (weirs) on the outside of the isopipe. The temperature of the glass is higher and its viscosity is lower at these portions of the isopipe as compared to the isopipe's lower portions since as the glass travels down the isopipe, it cools and becomes more viscous.

The solubility and diffusivity of zirconia in molten glass is a function of the glass' temperature and viscosity (i.e., as the temperature of the glass decreases and the viscosity increases, less zirconia can be held in solution and the rate of diffusion decreases.) As the glass nears the bottom (root) of the isopipe, it becomes supersaturated with zirconia. As a result, zircon crystals (i.e., secondary zircon crystals) nucleate and grow on the zircon isopipe in the region of the root.

Eventually these crystals grow long enough to break off into the glass flow and become defects at or near the fusion line of the sheet. Typically, breaking off does not become a problem until the crystals have grown to a length of around 100 microns. Growth to this length can take a substantial period of time, e.g., three or more months of continuous operation. As a result, the identification of the source of the secondary zircon defects in the finished glass was itself an important aspect of the invention.

### THE SOLUTION TO THE PROBLEM

In accordance with the invention, the problem of secondary zircon defects in the finished glass is solved by operating the fusion process under conditions that cause:

(a) less zirconia to go into solution in the trough and the upper portions of the isopipe, and/or

(b) less zircon to come out of solution and form secondary zircon crystals at the bottom of the isopipe (this coming out of solution may be considered as involving devitrification and/or precipitation of the zircon crystals).

Operating conditions that will achieve these effects include: (a) lowering the operating temperature (specifically, the glass temperature) at the top of the isopipe (trough and weir regions), or (b) raising the operating temperature (specifically, the glass temperature) at the bottom of the isopipe (root region), or (c) most preferably, lowering the operating temperature at the top and raising the operating temperature at the bottom of the isopipe.

Preferably, lowering the operating temperature at the top of the isopipe is used to solve the secondary zircon problem, either alone or in combination with raising the temperature at the bottom of the isopipe. In general terms, a temperature change at the top of the isopipe is approximately twice as effective as the same temperature change at the bottom of the isopipe in solving the secondary zircon problem.

The desired temperature adjustments at the top and/or bottom of the isopipe are achieved using heating equipment of the type conventionally employed to control glass temperatures in a glass forming operation. For example, lowering the operating temperature at the top of the isopipe can be achieved by turning down (or off) any heaters located at or near the top of the isopipe, while increases in the operating temperature at the bottom of the isopipe can be achieved by increasing the heat output of heaters located at or near the bottom of the isopipe, and/or by using more powerful heaters, and/or by adding more heaters.

Similarly, temperature adjustments can be achieved by changes in the insulation and/or air flow patterns around the isopipe, e.g., the insulation in the region of the root of the isopipe can be increased to increase the temperature in the region of the root and/or the air flow in that region can be reduced, again to increase the temperature in that region of the isopipe.

The temperature at the top of the isopipe can also be lowered by lowering the temperature of the glass supplied to the isopipe from the melting/fining equipment used to process the raw materials from which the glass sheet is made. By whatever means the temperature at the top of the isopipe is reduced, for a given glass composition, the result will be an increase in the viscosity of the glass and a reduction in the zirconia solubility in this region.

### BRIEF DESCRIPTION OF THE DRAWINGS

FIG. 1 is a schematic drawing illustrating a representative overflow downdraw fusion process for making flat glass sheets.

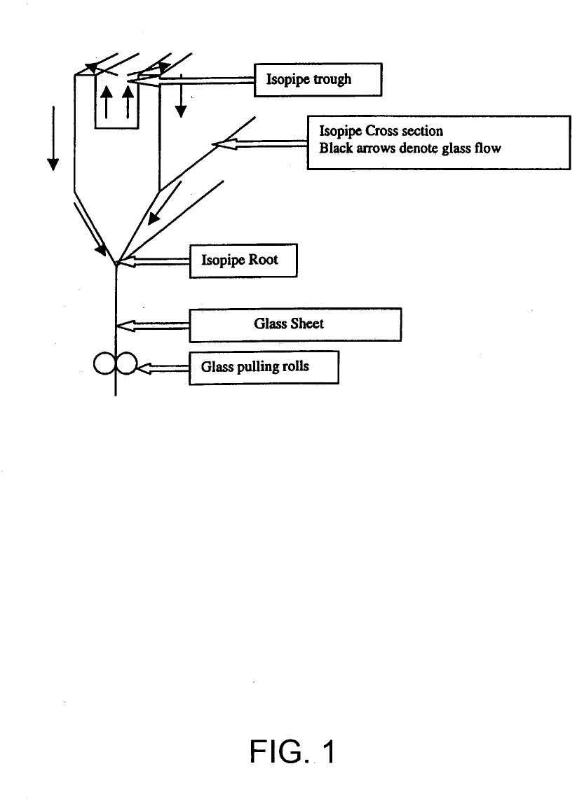

FIG. 2 is a schematic drawing illustrating representative temperature changes that can be employed in the practice of the invention.

### SPECIFIC EMBODIMENTS OF THE INVENTION

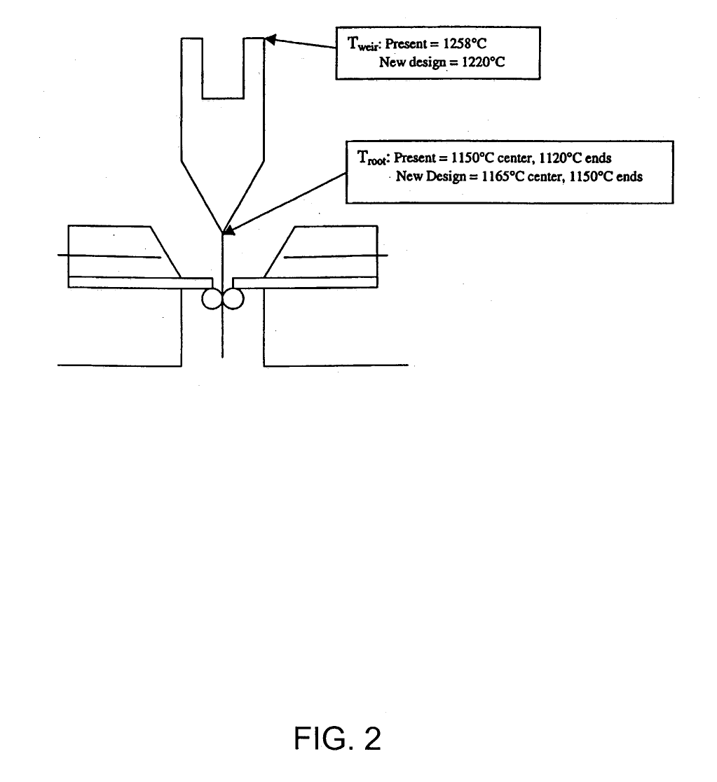

FIG. 2 show representative changes in operating temperatures designed to achieve a reduction in the level of secondary zircon defects from approximately 0.3 defects per pound to approximately 0.09 defects per pound, i.e., the level of defects with the invention is less than ⅓ of the level without the invention. It should be noted that the temperature change (increase) at the ends of the root are greater than the temperature change (increase) at the center of the root since the ends of the root are the places where secondary zircon crystals are more likely to form on the root of the isopipe.

Preferably, the temperatures shown in FIG. 2 are used in combination with a reduction in the temperature of the glass supplied to the trough of the isopipe, e.g., a reduction from approximately 1270° C. to approximately 1235° C.

The temperatures shown FIG. 2 are glass temperatures which can be measured using various techniques known in the art. In general terms, for the upper portions of the isopipe (trough and weirs), the measured temperature of the glass will be about the same as the temperature of the outer surface of the isopipe, while for the lower portions (root), the temperature of the glass will typically be lower than the temperature of the outer surface of the isopipe.

The temperature changes shown in FIG. 2 are suitable for use in producing LCD glass of the type sold by Corning Incorporated under the 1737 trademark. See U.S. Pat. No. 5,374,595 to Dumbaugh, Jr. et al. Suitable operating temperatures (glass temperatures) for other glasses can be readily determined from the present disclosure. The specific temperatures used will depend on such variables as glass composition, glass flow rate, and isopipe configuration. Thus, in practice, an empirical approach is used with the temperatures being adjusted until the levels of secondary zircon defects in the finished glass are at a commercially acceptable level, e.g., at a level of less than 0.1 defects per pound of finished glass. In general terms, for glasses suitable for making LCD substrates, the temperature difference between the glass at the top of the isopipe (e.g., at the top of the weir) and the temperature of the glass at the bottom of the isopipe (e.g., at the root) needs to less than about 90° C. and in some cases less than about 80° C. to avoid levels of secondary zircon defects above 0.1 defects per pound.

### SUMMARY

From the foregoing, it can be seen that the present invention provides methods for reducing the level of zircon-containing defects in sheet glass produced using fusion processes which employ zircon isopipes. The methods involve controlling the difference in temperature between the hottest and coldest glass which contacts the isopipe so that substantial amounts of zirconia do not go into solution where the hottest glass contacts the isopipe and substantial amounts of zircon do not come out of solution and form crystals where the coldest glass contacts the isopipe. In particular, the difference in temperature is controlled so that the secondary zircon crystals which form at the root of the isopipe do not reach a length where they will break off and produce commercially unacceptable levels of defects in the finished glass, e.g., levels of defects greater than 0.1 defects per pound of finished glass.

Even more succinctly, the present invention solves the secondary zircon defect problem by controlling the temperature profile of the glass as it passes over the zircon isopipe so as to minimize both the amount of zirconia which diffuses into the glass at the trough and weir level and the amount of zircon which comes out of solution and forms crystals at the root level.

What is claimed is:

1. In a method for producing sheet glass by a fusion process in which molten glass is supplied to a zircon isopipe which comprises a trough and weirs at its top and a root at its bottom, the improvement comprising controlling the formation of zircon-containing defects in the sheet glass by controlling the temperature profile of the glass as it passes over the zircon isopipe so as to minimize both the amount of zirconia which diffuses into the glass at the trough and weir level and the amount of zircon which comes out of solution and forms crystals at the root level.

2. The method of claim 1 comprising the step of lowering the glass temperature at the top of the isopipe.

3. The method of claim 2 wherein the glass temperature at the top of the isopipe is less than 1258° C.

4. The method of claim 1 comprising the step of increasing the glass temperature at the root of the isopipe.

5. The method of claim 4 wherein the glass temperature at the root of the isopipe is greater than 1120° C.

6. The method of claim 4 wherein the temperature increases at the ends of the root are greater than the temperature increase at the center of the root.

7. The method of claim 1 comprising the steps of lowering the glass temperature at the top of the isopipe and increasing the glass temperature at the root of the isopipe.

8. The method of claim 7 wherein the glass temperature at the top of the isopipe is less than 1258° C. and the glass temperature at the root of the isopipe is greater than 1120° C.

9. The method of claim 7 wherein the temperature increases at the ends of the root are greater than the temperature increase at the center of the root.

10. The method of claim 1 comprising the step of lowering the temperature of the glass supplied to the isopipe.

11. The method of claim 10 wherein the temperature of the glass supplied to the isopipe is less than approximately 1270° C.

12. The method of claim 1 wherein the temperature difference between the glass at the top of the isopipe and the temperature of the glass at the root of the isopipe is less than about 90° C.

13. The method of claim 12 wherein the temperature difference is less than about 80° C.

14. The method of claim 1 wherein zircon crystals which form at the root do not reach a length where they break off and produce commercially unacceptable levels of defects in the finished glass.

15. The method of claim 14 wherein the length of the zircon crystals which form at the root is kept below about 100 microns.

16. The method of claim 14 wherein the level of defects in the finished glass is less than or equal to 0.1 defects per pound.

17. The method of claim 1 further comprising using the sheet glass as a substrate for a further manufacturing process.

18. The method of claim 17 wherein the further manufacturing process is the production of liquid crystal displays.

19. In a method for producing sheet glass by a fusion process in which molten glass is supplied to a zircon isopipe which comprises a trough and weirs at its top and a root at its bottom, the improvement comprising controlling the formation of zircon-containing defects in the sheet glass by controlling the difference in temperature between the hottest and coldest glass which contacts the isopipe so that substantial amounts of zirconia do not go into solution where the hottest glass contacts the isopipe and substantial amounts of zircon do not come out of solution and form crystals where the coldest glass contacts the isopipe.
